(19) United States
(12) Patent Application Publication
(10) Pub. No.: US 2020/0013026 A1
(43) Pub. Date: Jan. 9, 2020

(54) SYSTEMS AND METHODS FOR BLOCKCHAIN ADDRESSES AND OWNER VERIFICATION

(71) Applicant: GMO GLOBALSIGN, INC., PORTSMOUTH, NH (US)

(72) Inventors: Willow White NOONAN, PORTSMOUTH, NH (US); Lancen LACHANCE, PORTSMOUTH, NH (US); Luuk VAN DEN BROEK, PORTSMOUTH, NH (US)

(73) Assignee: GMO GLOBALSIGN, INC., PORTSMOUTH, NH (US)

(21) Appl. No.: 16/503,414

(22) Filed: Jul. 3, 2019

Related U.S. Application Data
(60) Provisional application No. 62/768,049, filed on Nov. 15, 2018.
(60) Provisional application No. 62/693,713, filed on Jul. 3, 2018.

(51) Int. Cl. G06Q 20/06; G06Q 20/38

(52) U.S. Cl. CPC G06Q 20/0658; G06Q 20/3829; G06Q 2220/00; G06Q 20/38215; G06Q 20/389

(57) ABSTRACT

System and methods for secure blockchain transactions include forming, by one or more computing devices, a blockchain having a plurality of nodes, each node having a blockchain address. A certification certificate is requested from a certification server. The certification certificate is a trusted certificate that includes one or more fields to verify the identity of an entity associated with the transaction an address field containing a certified address of one of the blockchain nodes. The transaction is verified by determining that the entity is certified by the trusted certificate and that the certified address matches the first blockchain address.

### RELATED APPLICATIONS

This patent claims priority to and benefit of U.S. Provisional Patent Application No. 62/768,049 (filed Nov. 15, 2018) and U.S. Provisional Patent Application No. 62/693,713 (Filed Jul. 3, 2018). All documents cited in this section are incorporated here by reference in their entirety.

### FIELD

This disclosure relates to blockchains and, more specifically, blockchains with verification of identity.

### BACKGROUND

A blockchain is a growing list of records called blocks, that are linked together using cryptography, including cryptographic hashing. Each block in a blockchain can contain a cryptographic hash of the previous block, a time stamp, and transaction data. Once a block is recorded in the chain, the data in any given block cannot be altered retroactively without alteration of all subsequent blocks. Thus, blockchains are relatively resistant to modification and secure by design.

Some blockchains may be ingrained with units of value, e.g., ‘coins’ or ‘tokens,’ that are inextricably intertwined with the system. While a mere ledger provides an accounting of value, a blockchain can also store value. The Bitcoin blockchain represents the first and longest running of a new generation of internet protocols that store value.

Bitcoin is based on a proof-of-work system that requires energy and computational resources—more generally, labor—to produce new blocks and to claim the block reward. These computational resources required to produce each bitcoin minimize the trust needed to represent value because each bitcoin is a measure of sacrifice.

Every party to an exchange can be sure that a particular unit was created by work maintaining and securing the system and not by fiat or arbitrary decree, or by speculative debt obligation. In this sense, at least, Bitcoin's unforgeable nature and the resources required to produce it give it value. In other words, the work of mining bitcoin blocks goes to securing the Blockchain by making it unforgeable.

Specifically, the work of mining goes toward creating a data structure that maintains its integrity in the face of security compromises and network failures. Even if all computers in the Bitcoin network are taken offline and all private keys compromised, an attacker can only forge the Blockchain data structure by recreating all of the work needed to create it in the first place. For most attackers that is not feasible, even with time.

Moreover, the cost of securing the Blockchain by mining is recouped over time by the efficiencies gained from the system.

The unforgeably costly commodity repeatedly adds value by enabling beneficial wealth transfers. More of the cost of generating a bitcoin is recouped every time a transaction is made possible or made less expensive. The cost is amortized over many transactions. The monetary value of precious metals is based on this principle. It also applies to collectibles, which are more prized the rarer they are and the less forgeable this rarity is. It also applies where provably skilled or unique human labor is added to the product, as with art.

Thus, the work of mining Bitcoin secures the blockchain, and it is amortized over many transactions in which it is offset by gained efficiencies.

For all its virtues, the Blockchain is not necessarily computationally efficient compared to centralized and trust-based systems. This is primarily because, in their lowest layers, blockchains trade computational efficiency and scalability for social scalability, security, and unforgeability. That is, they trade a highly manageable and easily pliable computing platform for one that is open, redundant, and robust.

### SUMMARY

In an embodiment, a system comprises one or more computing devices maintaining a blockchain, the blockchain having one or more nodes (e.g., transactions) each comprising a blockchain address, the one or more computing devices capable of communicating with each other over a network. A server communicating on the network is configured to provide a certification certificate associated with an entity, wherein the certification certificate includes an address field containing at least one of the blockchain addresses to verify that the blockchain address is associated with the entity.

One or more of the following features may be included.

The blockchain may be bitcoin blockchain.

The blockchain address may be a bitcoin address.

The certification certificate may be an X.509 certificate.

The address field may be an extension field of the X.509 certificate.

The server may be associated with a certification service.

One or more of the computing devices may be configured to verify the identity of a respective entity by requesting the certification certificate from the server.

The one or more of the computing devices may be configured to conduct a financial transaction with the respective entity after verifying the identity of the respective entity.

The certification certificate may be associated with a cryptographic public key.

The blockchain node corresponding to the blockchain address contained in the certification certificate may also be associated with the cryptographic public key.

In another embodiment, a method for secure transactions includes forming, by one or more computing devices, a blockchain having a plurality of nodes, each node having a blockchain address, wherein a first node of the plurality of nodes has a first blockchain address associated with a transaction. A certification certificate is requested from a certification server, the certification certificate comprising one or more fields to verify the identity of an entity associated with the transaction and having an address field containing a certified address. The entity associated with the transaction is verified by determining that the certified address matches the first blockchain address.

One or more of the following features may be included.

Funds may be transferred to or from the first blockchain address after verifying that the entity is associated with the transaction.

The blockchain may comprise a bitcoin blockchain.

The blockchain address may be a bitcoin address.

The certification certificate may be an X.509 certificate.

The address field may be an extension field of the X.509 certificate.

The server may be associated with a certification service.

One or more of the computing devices may be configured to verify the identity of a respective entity by requesting the certification certificate from the server.

The one or more of the computing devices may be configured to conduct a financial transaction with the respective entity after verifying the identity of the respective entity.

The certification certificate may be associated with a cryptographic public key.

The blockchain node corresponding to the blockchain address contained in the certification certificate may also be associated with the cryptographic public key.

### BRIEF DESCRIPTION OF THE DRAWINGS

The foregoing features may be more fully understood from the following description of the drawings. The drawings aid in explaining and understanding the disclosed technology. Since it is often impractical or impossible to illustrate and describe every possible embodiment, the provided figures depict one or more exemplary embodiments. Accordingly, the figures are not intended to limit the scope of the invention. Like numbers in the figures denote like elements.

FIG. 1 is a block diagram of computing system including certification servers.

FIG. 2 is a block diagram of a blockchain.

FIG. 3 is a block diagram of a certification certificate.

FIG. 3A is a diagram of a system including a QR code.

FIG. 4 is a flowchart of a process for verifying the identity of an entity associated with a blockchain transaction.

FIG. 5 is a flowchart of a process for verifying the identity of an entity associated with a blockchain transfer.

FIG. 6 is a flowchart of a process for verifying the identity of an entity associated with a blockchain withdrawal.

FIG. 7 is a flowchart of a process for verifying the identity of an entity associated with a lightning network.

FIG. 8 is a block diagram of a computing device.

### DETAILED DESCRIPTION

The examples of the methods and systems discussed herein are not limited in application to the details of construction and the arrangement of components set forth in the following description or illustrated in the accompanying drawings. It will be understood to one of skill in the art that the methods and systems are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

One skilled in the art will recognize that, when describing blockchains, the term “block” is typically used to refer to blocks in a blockchain and the term “node” is typically used to refer to nodes in a lightning network. However, in this disclosure, the terms “block” and “node” are used interchangeably to refer to blocks in a blockchain, nodes in a lightning network, or both. The terms “block” and “node” may also be construed to mean any block or node appropriate in context of this disclosure.

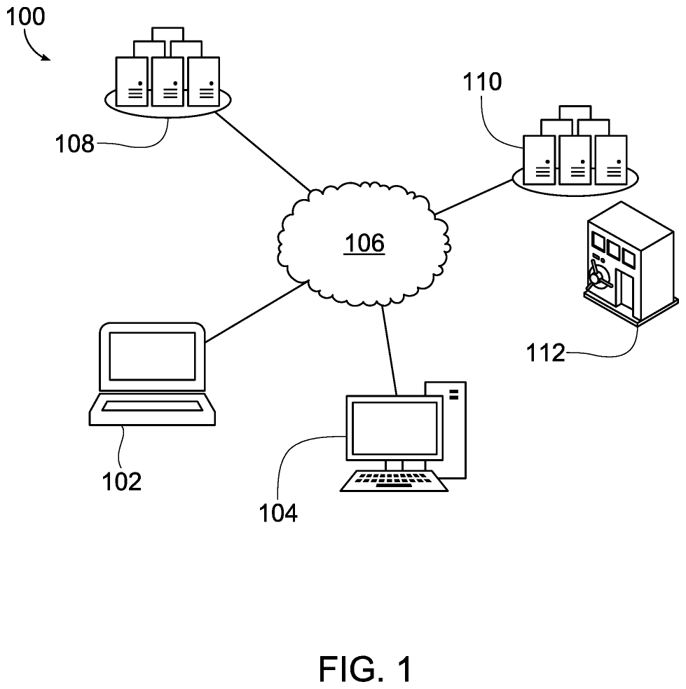

Referring to FIG. 1, a computing system 100 includes computing devices 102 and 104 communicating on network 106. Computing devices 102 and 106 may be any type of computing devices that can execute software instructions including, but not limited to, devices such as a desktop computer, a laptop computer, a mobile phone, a server, internet-of-things (IoT) sensor, embedded device, etc. Network 106 may be any type of network that allows computing devices to communicate with each other including, but not limited to, a WAN, a LAN, an internet, etc.

System 100 may also include one or more servers 108 that may be associated with a certification service. The certification service may be a service that issues or provides digital certificates that provide secure authentication of addresses, identity, transactions, signatures, etc. (for example, a certification authority (CA) corresponding to a public key infrastructure (PKI)). The certification service may also provide authentication using asymmetric cryptography (e.g., public-key cryptography using public/private key pairs) to establish the source of, or an entity's association with, data or transactions (e.g., by witnessing or authorizing a digital signature or transaction).

System 100 may also include servers 110 associated with an entity 112. The entity 112 may be a company, an individual, or any other legal entity with an identity that can be authenticated by servers 108. For example, a CA can verify a name, mailing address, Internet domain name, and Bitcoin address of an entity. Optionally, and also for example, a CA can establish ownership of a blockchain identifier (e.g., a Bitcoin address) by requiring an entity to prove ownership of a private key corresponding to the blockchain identifier (e.g., by providing a digital signature constructed using a private key corresponding to a Bitcoin address).

System 100 is shown as a relatively minimal system having two computing devices 102 and 104, servers 108 associated with a certification service, and servers 110 associated with an entity 112 communicating over a network 106. However, additional devices may also communicate over network 106 and interact with or be part of system 100. These devices are not shown for ease of illustration.

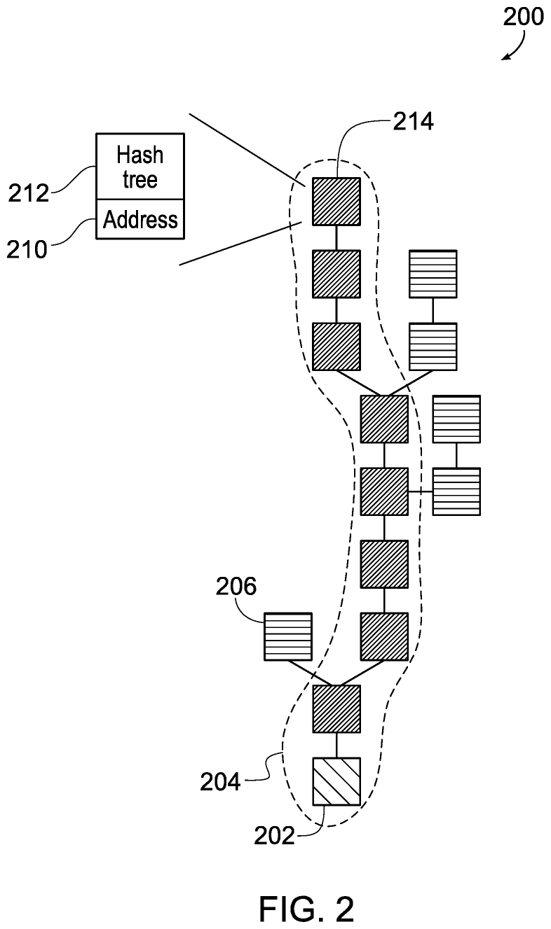

Referring also to FIG. 2, a blockchain 200 may be associated with system 100. Blockchain 200 may be stored, in whole or in part, by computing devices 102 and 104, and by servers 110. Other devices, not shown, may also store the entirety or store part of blockchain 200. In embodiments, blockchain 200 may be a bitcoin blockchain, a lightning network etc. (Note that, although the lightning network is not necessarily a blockchain, the systems and techniques described in this disclosure may operate on or in conjunction with the lightning network.) Blockchain 200 may be a public blockchain that allow participation by any entity or individual, like the Bitcoin blockchain or the Ethereum blockchain. In other embodiments, blockchain 200 may be a private blockchain with a closed group of users and private transactions, or a hybrid blockchain that may be governed by a group or consortium.

Regardless of the type of blockchain 200, various entities may be associated with transactions in the block chain. For example, blockchain 200 may include a bitcoin transaction that transfers funds from one entity to another. Optionally, the transaction may be associated with one or more source addresses (associated with entities authorizing inputs to the transaction) and/or a destination addresses (associated with entities potentially able to exercise rights over outputs of the transaction). Because of the secure nature of financial (and other) transactions, it may be beneficial if the parties to a transaction can authenticate the identity of the other parties of the transaction. For example, if the recipient is a bank, it may be beneficial for the transferor to authenticate the recipient address as associated with the proper bank.

Blockchain 200 may be created by, maintained by, and extended by computing devices such as devices 102 and 104. Blockchain 200 may include a series of blocks (also referred to as nodes in this disclosure) like origin block 202. The term “blockchain” may refer to the entire blockchain 200 structure or may refer to the longest uninterrupted chain within the structure. (e.g. blocks 204). Blockchain 200 may also include nodes (such as blocks 206) that branch from the main blockchain.

Each block may contain an address 210 associated with the block and used to accept and send blockchain transactions, and a hash tree 212 of data transactions. In embodiments, a block may be associated with a particular entity. Thus, the block's address 210 may also be associated with a particular entity. For example, if funds are transferred to address 210, those funds may become available to the entity associated with block 214.

The Lightning Network is a layer-2 protocol built on top of an underlying blockchain (e.g., Bitcoin). Pairs of users enter into agreements to negotiate in good faith secured by collateral. These agreements, called channels, can be recorded in blockchain 200 (for example, as ‘funding’ transactions).

Each pair updates the channel by using ongoing negotiations and partially signed but unrecorded contracts (i.e., ‘off-chain’) to adjust the allocation of the channel's collateral and defer settlement on the Blockchain.

To transfer funds, the sender updates unrecorded contracts with another party, who in turn updates one of his contracts with another party, and so on, until the process reaches the recipient. The result may be a chain of contractual updates.

Parties must negotiate in good faith (including by disavowing past revoked or updated contracts) or risk losing collateral in the lightning network. If negotiations break down and there is no dispute or breach, collateral can be returned according to the agreed allocation in the most recent contractual update.

By deferring recording to the Blockchain, the Lightning Network allows a higher transaction volume and near-instant confirmation:

The speed and capacity limits of the Blockchain itself do not directly limit Lightning transactions. Automated and near-instantaneous negotiations and contractual updates may not need to be recorded in the blockchain immediately—i.e., they can occur off-chain. However, in certain instances, the Blockchain limits the speed and volume of dispute resolution and settlement. Provided that disputes and settlements are much more infrequent than day-to-day transactions, the Lightning Network can achieve a very high degree of transactional scalability.

A standard Bitcoin transaction is usually not accepted as final or irrevocable (e.g., “confirmed) until it is included in the Blockchain—i.e., until it is included in a block with some number of additional blocks chained after it. Before a transaction makes it into a block, it is not yet part of the Blockchain and may still be susceptible to double-spending. The Blockchain's proof-of-work does not protect a transaction that is unconfirmed.

In the Lightning Network, although settlement to the Blockchain is deferred, it is deferred in a trust-minimized way. When a Lightning payment is completed, it may immediately receive the trust-minimized protection that comes with Lightning Network transactions—i.e., if a counterparty breaches an unrecorded contract, she forfeits her collateral. As a result, Lightning payments, while off-chain and technically unconfirmed, are effectively final, nearly instantaneously.

In the Lightning Network, bitcoins may oscillate back and forth within each individual channel. In a Lightning transaction, a single bitcoin may not move in a single transaction all the way from the initial sender to the ultimate receiver. Instead, the Lightning Network may form a vast network of oscillating bitcoins, with each individual bitcoin only moving back and forth within a single channel.

Like transformers for alternating current, nodes in the Lightning Network can maintain channels of different values, creating large channels with other ‘high-power’ nodes, while directly maintaining arbitrarily small channels with other users. In doing so, such nodes can act as transformers, converting a very high capacity flow to manageably small flows well-suited for day-to-day consumer transactions. Likewise, such nodes can aggregate small flows travelling in a similar direction for bundled transport over higher capacity channels. Where endpoint nodes have limited network connectivity or computational resources, such high-capacity nodes may also be able to handle some routing and channel-monitoring tasks. For example, a low-capacity node can outsource route-determination, potentially securely, to an trusted, authenticated higher-capacity or well-connected node.

Additionally, because a Lightning channel must be funded, nodes may have a large amount of available funds and may maintain more (and higher-valued) channels.

As highly connected hubs emerge in the Lightning Network, they will still be trust-minimized. Channels are protected by the rules of the Lightning Network, and nodes can unilaterally close channels.

While identities on the Lightning Network are largely static and public, transactions may be known only to counterparties—e.g. some partial information is available to intermediate nodes in a transaction, and some summary information is available on the public blockchain. A node's identity on the Lightning Network optionally can be associated with a public key.

Thus, in the Lighting Network, identity and reputation may be important to transactions. For example, reputation is important in seeking contracts and counterparties. Reputation enables parties to evaluate more efficiently whether a potential counterparty will honor representations about availability, connectivity, and fees. Reputation can be based on objectively observable network metrics, such as uptime, number and capacity of channels, and number of breaches and non-mutual settlements. Such information can be disseminated using trusted entities authenticated by a certification certificate.

Public identity allows for authentication of payees and merchants. In making purchases, for example, authenticated identities (e.g., using certification certificates associated with an entity and a public key) allow a user to verify that a payment is going to the intended merchant, and to validate invoices and receipts. Verified and authenticated identity is particularly important because it provides efficient protection against man-in-the-middle attacks, which are difficult to prevent in anonymized digital contexts without pre-existing trust.

Public key infrastructure (PKI), which can provide an efficient and contained point of trust, can address both of these needs—reputation and identity—without compromising the trust-minimized nature of the Blockchain.

For example, on the Lightning Network, a node can be represented by its public key and network identifier (e.g., an IP address or other endpoint identifier). That public key can correspond to the public key (or corresponding information in another field, for example, a subject attribute or X.509 extension) in a publicly trusted X.509 digital certificate. For example, referring again to FIG. 1, servers 108, which provide certification certificates, may provide those certification certificates (e.g., as X.509 certificates). This digital certificate, in turn, can be used to authenticate an identity of the node (by company or domain name, for example) as verified or confirmed by a certification authority (CA) or registration authority (RA). With authenticated Lightning nodes, users can, for example, ensure that payments are actually going to the intended merchant.

In some embodiments, a certificate (e.g., an X.509 certificate) issued for authentication in a layer-2 blockchain protocol (e.g., the Lightning Network) transaction, may include an invoice field that contains data relating to a potential transaction (e.g., destination, amount, time, signature of a destination or authorized party, or geographic location of one or participants). For example, if a merchant is requesting payment from a customer in a transaction for sale of goods or services, an X.509 certificate can include an invoice field (e.g., as a subject attribute or in an X.509 extension) that includes information related to the potential transaction (e.g., a standard Lightning Network invoice).

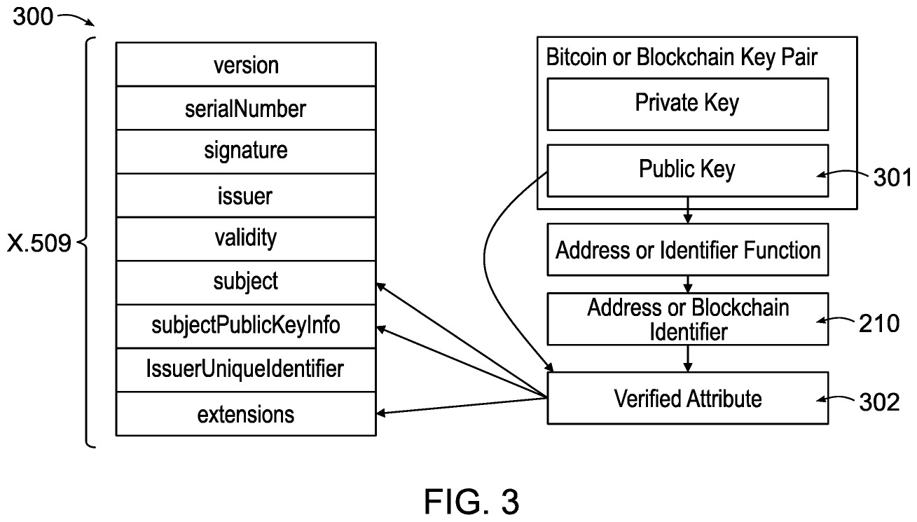

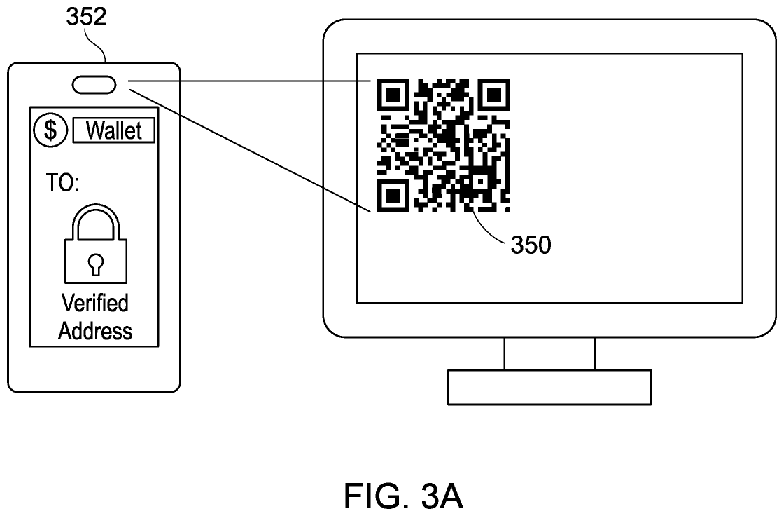

Referring to FIG. 3, a certification certificate 300 enabling verification of certain identity information associated with an entity may be issued by servers 108. Optionally, certification certificate 300 may comply with the X.509 format and may be an X.509 certificate. Optionally, certification certificate 300 may also be authorized or verified by a third-party, for example, some portions of or all of such certificate's data can be signed with a private key of a certification authority (CA) (e.g., a private key corresponding to a trusted or otherwise authorized digital certificate). In embodiments, address 210 and/or public key 301 may comprise, be used as, or be used to derive a verified attribute 302 and optionally may be included within a portion of certification certificate 300 signed or otherwise verified, for example, by a certification authority (CA) (e.g., signed by a CA's private key during issuance of certification certificate 300). A private key used by certification authority to sign certification certificate 300, may be provided by a trusted source, such as servers 108 which may be associated with a public certification service.

Certification certificate 300 may include various fields, including for example fields comprising, used as, or used to derive verified attributes 302. For example, certification certificate 300 can include a public key from which a verified Bitcoin address or blockchain identifier can be derived. Optionally, one or more fields in the certificate can contain one or more verified blockchain addresses (e.g., a Bitcoin address). The addresses may be the same address 210 found in blockchain block 214. Certification certificate 300 may also include information that identifies an entity, such as serial number, issuer name, validity, public key, unique ID, and other information including, but not limited to, information contained in fields shown as part of certification certificate 300. Optionally, some or all of such information may comprise, be used as, or be used to derive one or more verified attributes (e.g., a public key can comprise a verified attribute for an entity where the entity verifies possession of a corresponding private key). Thus, certification certificate 300 may associate and authenticate address 210 and/or public key 301 with a trusted entity.

Verified attributes 302 included in certification certificate 300 are not limited to blockchain addresses or public keys. For example, verified attribute may be an IP address, another type of network address, another unique identifier associated with a transaction within blockchain 200, an amount transferred in a transaction within blockchain 200, or any other data that can be associated with a blockchain transaction and/or an entity involved in the blockchain transaction. In embodiments, the verified attribute may be an address reference. For example, verified attribute 302 may indirectly reference an address via the public key of the X.509 certificate. Thus, certification certificate 300 can provide assurances that the entity listed in the certification certificate 300 is really the entity that is involved in the blockchain transaction associated with verified attribute 302.

Although shown as a separate field within the X.509 certificate, the verified attributes 302 may be stored anywhere within the X.509 certificate. Also, in embodiments, the verified attribute 302 may be stored separately from but associated with the X.509 certificate.

Referring to FIG. 3A, the certification certificate 300 can be encoded in a QR code 350. As an example, a QR code can, for example, encode a certificate in DER or PEM forms. QR code 350 may then be scanned by a computing device such as 352, which may include a hardware or software wallet. The computing device can verify the certification certificate in order to establish an identity of a counterparty in a transaction (e.g., an identity of a transferee in a Bitcoin transaction). The computing device can notify a user after validating the certification certificate, for example, by displaying identity information contained in the certification certificate along with an indication that the certificate is valid.

The certification certificate in the QR code may provide the wallet with verified identity of an entity associated with the QR code, or with the certification certificate, or with one or more potential or existing cryptocurrency or blockchain addresses, or with one or more potential or existing cryptocurrency or blockchain transactions (e.g., an on-chain Bitcoin transaction referencing or including a Bitcoin address), for example, by including a cryptocurrency or blockchain address, or public key corresponding to such address.

Optionally, the wallet can then verify the authenticity of the information based on the certification certificate. Also, optionally, the wallet can also verify the certificate in the QR code by, for example, requesting that servers 108 authenticate the certification certificate contained in the QR code, for example. The wallet can then engage in a transaction with the address with confidence that they are conducting transactions with the verified entity.

QR code 350 may, for example, encode both a certification certificate and an invoice. In certain instances, the invoice may be contained within the certification certificate. Additionally, or alternatively, QR code 350 may encode a certificate that contains information other than or in addition to cryptocurrency addresses or identifiers. For example, the QR code may contain a certification certificate that includes a URL, an account identifier, a user identifier, or a rolling or periodically changing identifier (e.g., an AliPay™, Line™, or WeChat Pay™ payment URL or account number).

Thus, for example, when an entity scans the QR code, the entity can verify the certification certificate and the information contained in the certificate or QR code to gain assurance that the QR code (and information within the QR code) is associated with the correct source.

Optionally, a QR code can encode an online location (e.g., a URL) or interface (e.g., an Internet-accessible API) where a certification certificate can be retrieved. A hardware device or software program (e.g., a hardware Bitcoin wallet) can then retrieve the certification certificate (e.g., by downloading it from a specified URL) and validate the certificate. For example, a user could use a Bitcoin wallet on a mobile device to scan a QR code encoding or otherwise referencing a URL, to retrieve a certification certificate from the URL, and to verify the retrieved certification certificate, including for example verifying identity information and a Bitcoin address contained within or derived from the certificate.

Optionally, the QR can include or encode information in addition to a location from which a certificate can be retrieved. For example, a QR code can include a destination blockchain or cryptocurrency address, along with a URL from which a certification certificate can be retrieved. Optionally, the certificate can be used to establish an identity corresponding to a cryptocurrency or blockchain address, and to ensure that such cryptocurrency or blockchain address matches the address encoded or included in the QR code. Optionally, the retrieved certificate can be used to check a digital signature included in, attached to, or otherwise related to information contained in the QR code (e.g., by checking that data included in the QR code has been validly signed by a private key corresponding to the certificate).

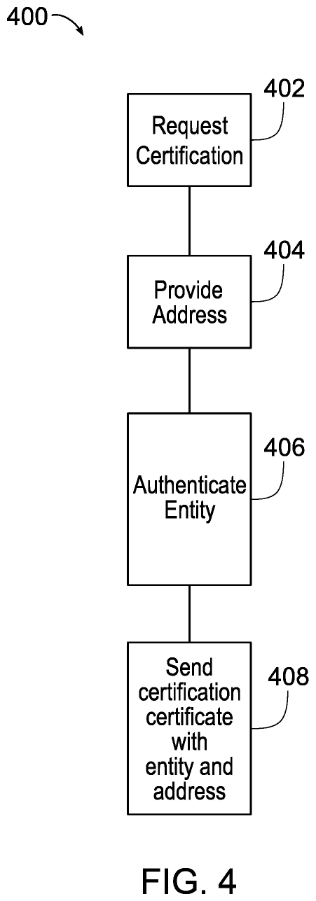

Referring to FIG. 4, a flowchart describes a general process 400 for authenticating a party to a blockchain transaction. Process 400 may be used by an entity that wants to prove its identity to other parties to a transaction, or by an entity that wants to gain assurance of the identity of the other parties to a transaction.

In step 402, a party requests certification from servers 108 that an entity (either the requesting party itself or another party associated with the transaction) is not an imposter. Optionally, the request can include identifying information about the entity including, but not limited to: a device fingerprint, a domain verification, biometric data, video verification a 2FA token, challenge questions and/or answers, a street address, a phone number, a network address, a unique identifier, an encryption key, etc. The identifying information may also be established by contacting, by the certification service, via phone or text message to verify the entity's identification.

In step 404, the party requesting the certification sends the address (i.e. address 210) to servers 108. The address may comprise a blockchain identifier, for example, a public key or a blockchain or cryptocurrency address (e.g., a Bitcoin address). Also for example, a transaction within the blockchain, or any other type of blockchain activity that the entity is engaged in.

In step 406, servers 108 authenticate the identity of the entity. In some cases, for example if the address is static, servers 108 may also authenticate that the supplied address is associated with the entity. This may be done by decrypting the address, checking the address against a database, or in some other way linking the address to the entity through data association. For example, servers 108 can verify possession of a private key corresponding either to the address or to a public key corresponding to the address (e.g., a public key from which a cryptocurrency address is or can be derived). Also for example, association of an entity with a public key or address can be established or assumed based in whole or in part on one or more of the following: (1) requiring a signature, by the private key corresponding to the public key or address, on a request to the servers 108, (2) requiring a signature, by the private key corresponding to the public key or address, on its corresponding public key, (3) requiring a signature, by the private key corresponding to the public key or address, on an address corresponding to its public key, or (4) requiring a requesting entity to participate in an interactive signing protocol, for example, by providing a nonce value and requiring a signature, by the private key corresponding to the public key or address, on the nonce value.

If the entity and the address are authenticated, servers 108 may issue and send a certification certificate (such as certification certificate 300) to the requestor that associates the entity with the provided address. The certificate may then be provided to other parties to the transaction to provide assurances that the entity involved in the transaction is actually the entity listed in the certification certificate.

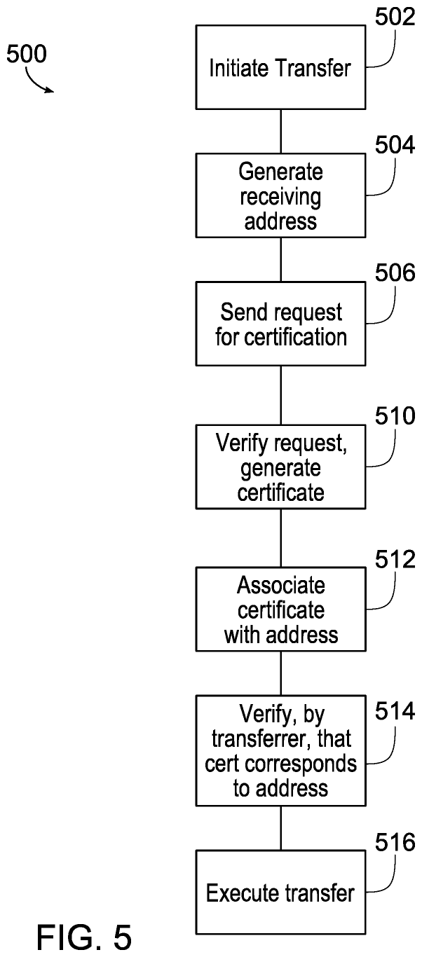

Referring to FIG. 5, a flowchart depicts a process 500 for requesting and/or receiving funds through a blockchain transaction. In step 502, a party initiates a transfer of funds by requesting funds from another, second party. In step 504, the first party generates a receiving address (e.g. address 210) to which the funds can be transferred.

In step 506, the first party (or another party) sends a request to servers 108 for a certification certificate that authenticates the identity of the first party. The request includes identifying information about the first party as well as the receiving address generated in step 504. In step 510 servers 108 authenticate the identity of the first party (for example, using one or more of the techniques described above).

If servers 108 can authenticate the first party's identity, they generate a certification certificate and associate the receiving address with the certification certificate. The certification certificate can then be sent to the transferor of funds which can, in step 514, verify, through the certification certificate, that the address provided is indeed an address associated with the first party. In step 516, the transfer of funds can be initiated.

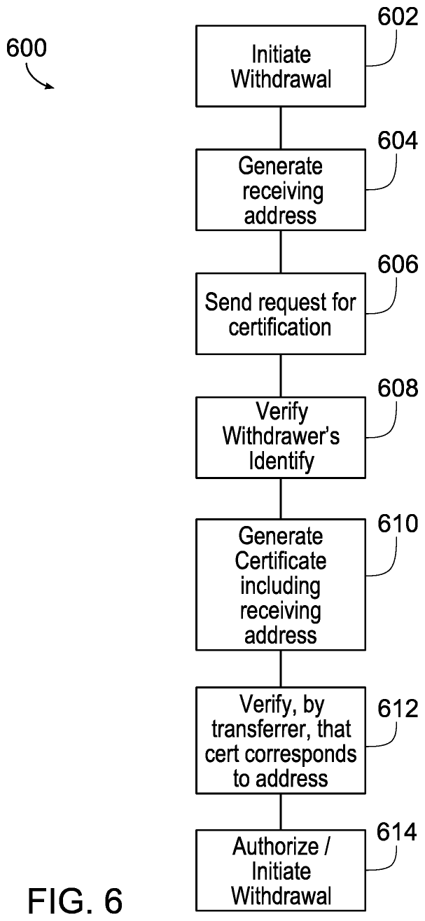

Referring to FIG. 6, a flowchart depicts a process 600 for withdrawing funds through a blockchain transaction. In step 602, the withdrawing party initiates a withdrawal and, in step 604, generates an address that the funds should be transferred to. In step 606, the withdrawing party (or another party) sends a request to servers 108 for certification of the withdrawing party's identify. The request for certification includes the receiving address generated in step 604.

In step 608, servers 108 verify the withdrawing party's identity by, for example, on of the methods of identification discussed above. If servers 108 can identify the withdrawing party's identity, servers 108 may generate a certification certificate in step 610. The certification certificate may include the receiving address generated in step 604. Thus, the certification certificate can provide verification that the receiving address is associated with the correct withdrawing party.

The certification certificate can then be provided to the transferor which, in step 612, can verity that the receiving address is associated with the correct withdrawing party. After verification, the transferor may authorize and/or initiate the withdrawal in step 614.

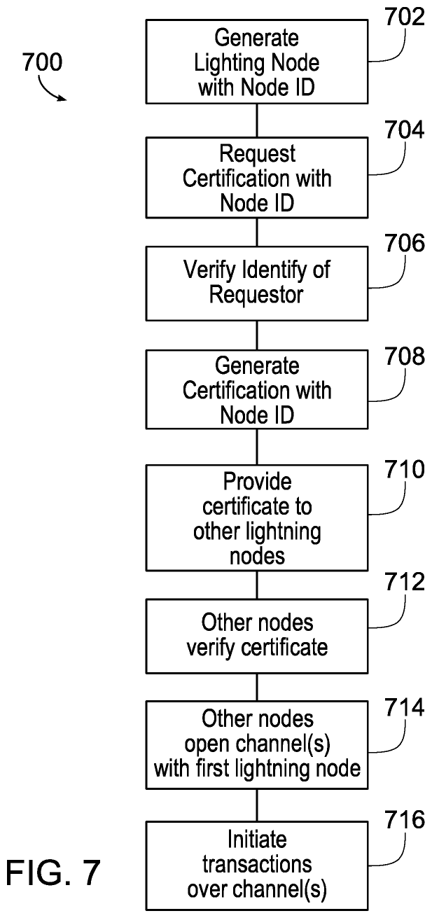

Referring to FIG. 7, a flowchart depicts a process 700 for establishing a channel in a lighting network. In step 702, a new lightning node with a lightning ID is generated. The entity of the new lightning node can request that servers 108 generate a certification certificate in step 704. The request may include the new node ID.

In step 706, servers 108 may verify the identity of the entity requesting verification by, for example, using one of the techniques discussed above. If the identity is verified, in step 708, servers 108 may generate a certification certificate that validates the identify of the entity associated with the new lightning node and associates the new lightning node ID with the verified entity.

In step 710, the certification certificate can be provided to other lightning nodes which may then, in step 712, verify the identify of the new lightning node. In step 714, the other lightning nodes may open channels with the new lightning node and, in step 716, initiate transactions with the new lightning node over the channels.

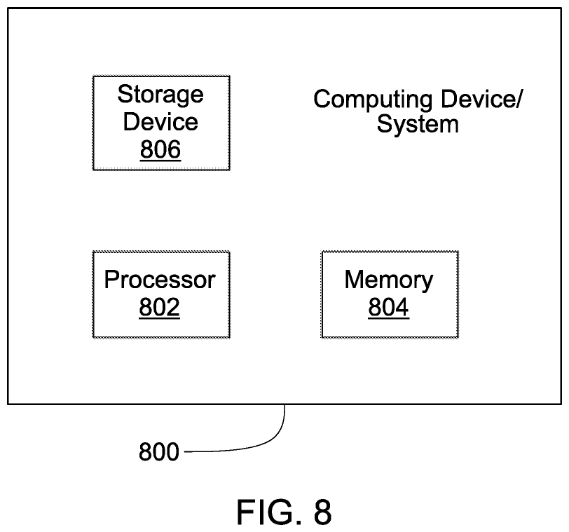

Referring to FIG. 8, an exemplary computing system 800 may be used to perform some, all, or parts of the processes and methods described above. For example, computing devices 102 and 104 and servers 108 may comprise variations of computing system 800. These devices may maintain and create blockchains, perform blockchain transactions, and perform methods to verify identity and addresses, as described above, for example.

Computing system 800 includes a processor 802 (which may be the same as or similar to processor 110), a random access memory (RAM) 804, and a storage device 806, which may be a hard drive, a CD, a DVD, a flash drive, or any other type of non-volatile memory. Software instructions may be stored in RAM 804 and/or storage device 806. Processor 802 may be coupled to storage device 806 and/or RAM 704 so that processor 802 can read the software instructions. As processor 802 reads the software instructions, the software instructions may cause processor 802 to perform operations, as described above, for computing the position of a magnetic target. Although not shown, processor 802 and/or system 800 may include other inputs and outputs, such as inputs for receiving the signals from the sensing elements, GPIO, power inputs, or other interfaces such as USB, SATA, HDMI, and the like.

The systems and techniques described above can be for verification of an entity involved in any blockchain transaction. For example, a publicly trusted X.509 digital certificate would allow a user (and software and hardware wallets) to verify that a particular blockchain address is in fact controlled by the intended recipient rather than a man-in-the-middle. A software or hardware wallet can also use an X.509 digital certificate to verify the identity of a recipient.

The systems, devices, and methods described above are example systems, devices, and methods shown for the purpose of understanding and illustration. Variations on these systems, devices, and methods are within the scope of the disclosure. Also, equivalent systems, devices, and methods are within the scope of the disclosure. Flowcharts illustrated in the figures and described in the disclosure do not necessarily require any particular order of the steps. Also, various steps may be added, removed, rearranged, and reordered as desired to produce the same or similar results and remain within the scope of this disclosure.

Various embodiments are described in this patent. However, the scope of the patent should not be limited to the described embodiments, but rather should be limited only by the spirit and scope of the following claims. All references cited in this patent are incorporated by reference in their entirety.

1. A system comprising:
one or more computing devices maintaining a blockchain, the blockchain having one or more nodes each comprising a blockchain address, the one or more computing devices capable of communicating with each other over a network;
a server communicating on the network and configured to provide a certification certificate associated with an entity, wherein the certification certificate includes an address field containing at least one of the blockchain addresses to verify that the blockchain address is associated with the entity.

2. The system of claim 1 wherein the blockchain comprises a bitcoin blockchain.

3. The system of claim 2 wherein the blockchain address is a bitcoin address.

4. The system of claim 1 wherein the certification certificate is an X.509 certificate.

5. The system of claim 4 wherein the address field is an extension field of the X.509 certificate.

6. The system of claim 1 wherein the server is associated with a certification service.

7. The system of claim 1 wherein one or more of the computing devices is configured to verify the identity of a respective entity by requesting the certification certificate from the server.

8. The system of claim 7 wherein the one or more of the computing devices is configured to conduct a financial transaction with the respective entity after verifying the identity of the respective entity.

9. The system of claim 1 wherein the certification certificate is associated with a cryptographic public key.

10. The system of claim 9 wherein the blockchain node corresponding to the blockchain address contained in the certification certificate is associated with the cryptographic public key.

11. A method for secure transactions comprising:
forming, by one or more computing devices, a blockchain having a plurality of nodes, each node having a blockchain address, wherein a first node of the plurality of nodes has a first blockchain address associated with a transaction
requesting a certification certificate from a certification server, the certification certificate comprising one or more fields to verify the identity of an entity associated with the transaction and having an address field containing a certified address; and
verifying that the entity is associated with the transaction by determining that the certified address matches the first blockchain address.

12. The method of claim 11 further comprising transferring funds to or from the first blockchain address after verifying that the entity is associated with the transaction.

13. The method of claim 11 wherein the blockchain comprises a bitcoin blockchain.

14. The method of claim 13 wherein the blockchain address is a bitcoin address.

15. The method of claim 11 wherein the certification certificate is an X.509 certificate.

16. The method of claim 15 wherein the address field is an extension field of the X.509 certificate.

17. The method of claim 11 wherein the server is associated with a certification service.

18. The method of claim 11 wherein one or more of the computing devices is configured to verify the identity of a respective entity by requesting the certification certificate from the server.

19. The method of claim 18 wherein the one or more of the computing devices is configured to conduct a financial transaction with the respective entity after verifying the identity of the respective entity.

20. The method of claim 11 wherein the certification certificate is associated with a cryptographic public key.

21. The method of claim 20 wherein the blockchain node corresponding to the blockchain address contained in the certification certificate is associated with the cryptographic public key.
